(19) United States
(12) Patent Application Publication
(10) Pub. No.: US 2005/0102470 A1
(43) Pub. Date: May 12, 2005

(54) Disk array device

(75) Inventor: Tsutomu Ishizaki, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/974,955

(22) Filed: Oct. 28, 2004

(30) Foreign Application Priority Data
Nov. 11, 2003 (JP) 2003-381044
Sep. 21, 2004 (JP) 2004-272947

(51) Int. Cl. G06F 12/16

(52) U.S. Cl. 711/114; 711/202; 711/165

(57) ABSTRACT

There are provided a plurality of physical disks and a controller for performing reading and writing of data to the storage areas of the physical disks according to instructions from a host device. In each physical disk, the storage area is divided into a number of areas, and a divided storage area of one physical disk is set to make a pair with a divided storage area of another physical disk. Data is managed by using divided storage areas of different physical disks set to be in a pair, whereby improvement in reliability, cost reduction and miniaturization can be achieved.

### BACKGROUND OF THE INVENTION

1. Field of the Invention

The present invention relates to disk array devices, and in particular, disk array devices capable of improving the fault tolerance of physical disks, reducing the product cost, and realizing miniaturization.

2. Related Art

In recent years, computers are introduced not only in companies but also at home, so that dependence on IT (Information Technology) is growing. Along with this situation, the importance of electronic data handled in computer systems is further rising, and the role of storages in computer systems for storing such electronic data is getting more important than ever. This leads to growing demands for higher performance and larger capacity of storages, and in particular, for higher reliability.

In the state of the storage capacity being increasing, electronic data written on a large-capacity physical disk has been copied to a spare physical disk or the like in case of a fault of the physical disk conventionally, in order to maintain the reliability of the electronic data. In such a system, however, once the fault of the physical disk (main disk) is recovered, the electronic data which has been saved on the spare physical disk must be copied again to the main disk. The period required for copying is in proportion to the storage capacity of the physical disk. This causes a problem of longer period being required as the storage capacity increases.

In order to maintain data redundancy and to speed up reading and writing of data performed to physical disks, most of the current hard disks adopt a system, in which a hard disk is composed of a number of physical disks, and data is divided and stored on respective physical disks (so-called RAID: Redundant Arrays of Inexpensive Disks). Further, a fault countermeasure technique for such multiplex hard disks, that is, a technique for securing data redundancy, has been studied conventionally. Examples are shown in Japanese Patent Application Laid-open No. 7-129331A (Patent Document 1) and Japanese Patent Application Laid-open No. 2000-148409A (Patent Document 2).

An explanation will be given for the art disclosed in Patent Document 1 with reference to FIG. 1. In a disk array device 200 disclosed in Patent Document 1, data writing is performed based on the RAID system controlled by a RAID controller 250 according to an instruction from a host device 300. More specifically, FIG. 1 shows the RAID 5 system, which adopts a system of dividing writing data into pieces of data by the number of physical disks, generating a piece of parity data corresponding to each divided data, and by making a pair with a piece of divided writing data and a piece of parity data, writing the paired data onto each of the ten physical disks 210-219, respectively. In the ten physical disks, however, other physical disks 220-229 making pairs, respectively, are provided. In other words, two physical disks constitute a pair in such an example. In FIG. 1, the pair of physical disks are two physical disks encircled by a virtual line. For example, the physical disks indicated by the numerals 210 and 220 correspond to the pair. Data DA1-DA10 written on the data area of one of the physical disks 210-219 is copied to another data area making a pair. Thus, mirror data DA1′-DA10′, which has the same content as each of the data DA1-DA10 consisting of a divided piece of writing data and a piece of parity data, is written on another physical disk making a pair.

However, such a system causes a problem that the cost required for a disk device increases as the number of physical disks increase. Further, there is another problem that the space occupied by the physical disks increases, so that the disk array device cannot be miniaturized.

FIG. 2 shows the art disclosed in Patent Document 2, which also uses the RAID 5 system. This example has such a configuration that when writing data according to an instruction from a host device 500, dividing the writing data by the number of physical disks, that is, ten physical disks shown in this Figure, generating a piece of parity data corresponding to each divided piece of writing data, and making a pair with the divided writing data and the parity data, writing the paired data onto each of the ten physical disks DA1-DA10 (410) by a RAID controller 450.

Such a disk array device 400 uses a redundant disk system, and has a longitudinal redundant disk drive 420 and a lateral redundant disk drive 430, as shown in FIG. 2. Then, by generating lateral and longitudinal parity of the data disk drive 410 onto which divided data and parity data are stored, and storing them onto the lateral redundancy disk drive 430 and the longitudinal redundancy disk drive 420, data can be restored more securely when a number of physical disks are failed.

However, even with such a configuration, there are problems of an increase in cost for the physical disks and miniaturization being impossible due to an increase in the accommodating space since the number of physical disks is large, as same as those of Patent Document 1. Further, when one physical disk is failed, data corresponding to the data stored in such a physical disk is temporarily copied to a redundant disk and then the data is copied from the redundant disk to the replaced physical disk to thereby complete the reconstruction. Thereby, there is caused another problem that the nonredundant state exists in the system using a redundant disk.

Therefore, disk array devices capable of suppressing an increase in time spent for data restoration and suppressing an increase in the number of physical disks are demanded.

### SUMMARY OF THE INVENTION

It is therefore an object of the present invention to provide disk array devices with large capacity, capable of improving reliability and realizing higher writing speed, cost reduction, and miniaturization.

In order to achieve the aforementioned object, a disk array device of the present invention comprises: a plurality of physical disks; and a controller which performs reading and writing of data to storage areas of the physical disks based on instructions from a host device. In each of the physical disks, the storage area is divided into a plurality of areas, and divided storage areas of one physical disk are set to make pairs with divided storage areas of another physical disk.

The pairs are made between a divided storage area of one physical disk and a divided storage area of another physical disk, and between a divided storage area of the one physical disk and another divided storage area of the other physical disk. Alternatively, the pair is made between a divided storage area of one physical disk and a divided storage area of another physical disk.

The controller holds correlation data for corresponding storage areas making a pair to each other, and has a managing function of maintaining the same data on the pair of storage areas, based on the correlation data.

The storage area of each physical disk is preferably divided into two storage areas having the same storage capacity.

With this configuration, data on a divided storage area of a physical disk is copied to a divided storage area of another physical disk. Further, data on another divided area of the physical disk is copied to a divided area (storage area) of a physical disk other than the above two physical disks. Further, if there is another divided area, the data is further copied to a divided are of yet another physical disk. In this way, one physical disk contains a number of pieces of data, whereby the pieces of data written on one physical disk are, by each piece of data on one divided area, copied to and written on divided areas formed on different physical disks, respectively. Accordingly, if a number of physical disks are failed, data can be easily restored, and the data reliability can be improved. Further, it is also possible to suppress an increase in the number of physical disks, and to realize reduction in device cost and miniaturization. In particular, since all divided areas have the same capacity, every data is surely copied, which enhances the data reliability.

One of storage areas making a pair is set as a writing area onto which original data is written. The controller preferably holds writing area specifying data for specifying the storage area as a data writing area, and has a function of writing, on the storage area, writing data corresponding to instructions from a host device, based on the writing area specifying data, and also has a function of copying the same data as that written on the storage area to a storage area making a pair therewith.

With this configuration, the data reliability is secured as described above, and also it is possible to suppress unnecessary increase in physical disks and to save accessing time when reading out. Further, when writing data, writing is performed to only one of the physical disks being paired, and then the written data is copied. Thereby, data writing can be performed in higher speed, while enhancing the data reliability.

It is preferable that the controller have a function of recognizing a replacements of a physical disk, and upon recognition of the replacement, have a function of copying data, stored on a storage area of another physical disk making a pair, to a storage area of the physical disk replaced.

With this configuration, when physical disks are failed, the physical disks are replaced and the data is copied to the new divided area replaced. Thereby, restoration will be performed quickly and easily, which further enhances the data reliability.

### EFFECT OF THE INVENTION

As described above, the present invention is so configured that when a physical disk is degenerated due to a fault, the physical disk can be replaced in the state of maintaining redundancy, since the data on the physical disk has been copied to another physical disk. This process does not cause a risky nonredundant period, so that the data reliability is enhanced. In a disk device according to the conventional art, when a physical disk with large capacity is degenerated due to a fault, a nonredundant state is caused until copying to a redundant disk (hot spare of the like) is completed. The duration of this risky period is in proportion to the capacity of the physical disk. In contrast, the present invention provides excellent effect.

Further, the present invention has a redundancy as described above, and is also capable of suppressing an unnecessary increase in the number of physical disks, and realizing cost reduction and miniaturization, though it is a disk array device with high reliability. Therefore, as the number of physical disks used for data writing increases, the present invention exhibits such an advantageous effect as to improve fault tolerance against multiple faults, and to realize cost reduction.

### BRIEF DESCRIPTION OF THE DRAWINGS

FIG. 1 is a schematic diagram showing the configuration of a conventional disk array device;

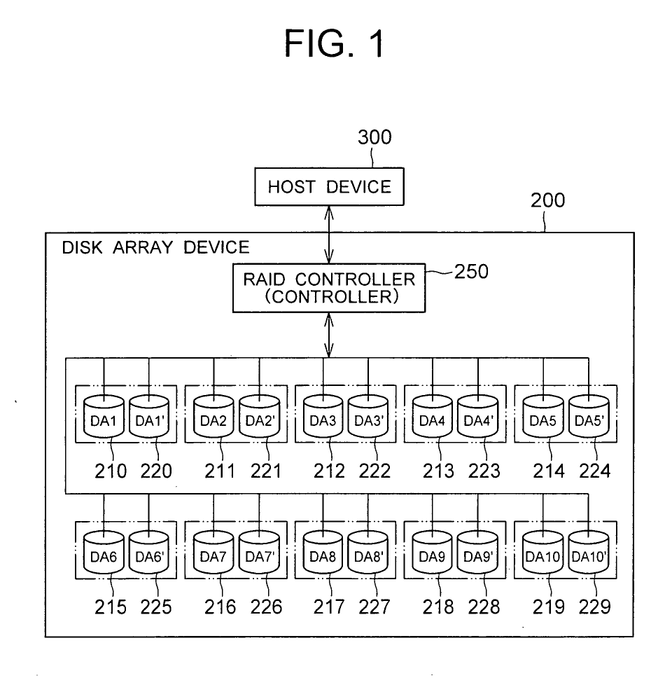

FIG. 2 is a schematic diagram showing the configuration of a conventional disk array device;

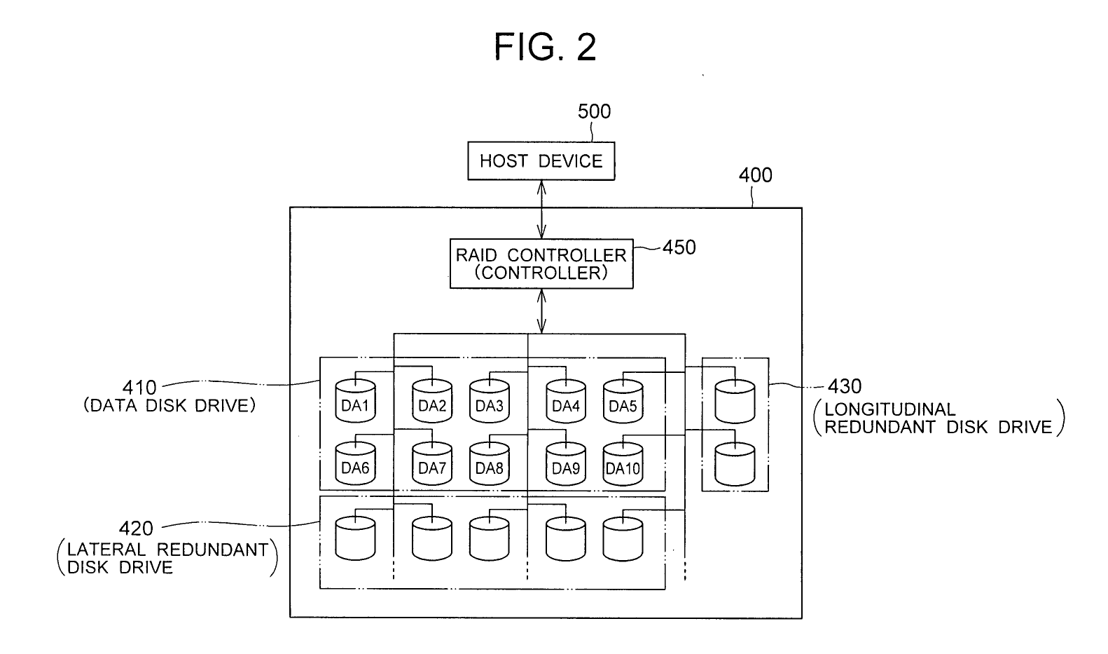

FIG. 3 is a schematic diagram showing the configuration of a disk array device of the present invention;

FIG. 4 is a conceptual illustration showing the state of storing data on the physical disks shown in FIG. 3;

FIGS. 5(a) and 5(b) are conceptual illustrations showing states of storing data on physical disks according to an embodiment, in which FIG. 5(a) shows a case of RAID 1, and FIG. 5(b) shows a case of RAID 5; and

FIGS. 6(a), 6(b) and 6(c) are conceptual illustrations showing the state of storing data onto physical disks according to an embodiment, in which FIGS. 6(a), 6(b) and 6(c) show states where several physical disks are failed, respectively.

### PREFERRED EMBODIMENT OF THE INVENTION

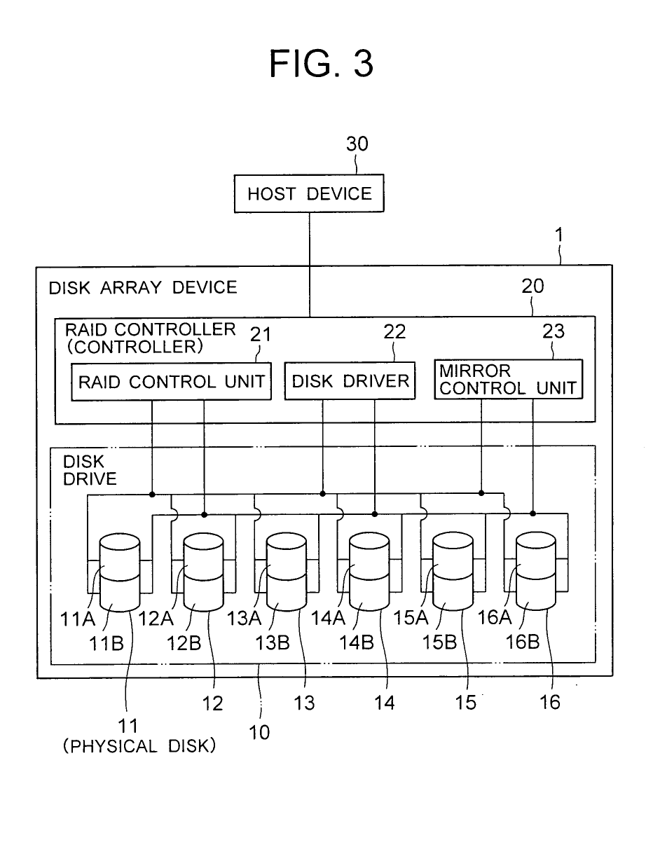

An embodiment of the present invention will be described with reference to FIGS. 3 to 6(a), (b) and (c).

As shown in FIG. 3, a disc array device 1 according to the present invention connects with a host device 30, and reads and writes data according to instructions from the host device 30. The disc array device 1 includes a disk drive 10 composed of a number of physical disks, and a controller 20 (RAID controller) for controlling the physical disks to read and write data. In other words, the controller 20 has, as described later, a management function of holding correlation data for corresponding a pair of storage areas to each other, and based on the correlation data, maintaining the same data on the storage areas making a pair.

In the disk drive 10, six physical disks 11-16 are stored in FIG. 3, and each of the physical disks 11-16 is set in advance to be divided into two areas, each data storage area having the same storage capacity. Here, divided areas of each physical disk 11-16 are called blocks, in which one is called a block A, and the other is called a block B. The divided block A and block B are set to have the same storage capacity. That is, the physical disks 11-16 are divided into divided areas of 11A and 11B, 12A and 12B, 13A and 13B, 14A and 14B, 15A and 15B, and 16A and 16B, each of which has the data storage area of a half storage capacity. Note that the number of physical disks and the number of divided areas are not limited to those described above. Further, the storage capacity of the divided storage area of each physical disk is not limited to be the same capacity, but may be different.

Further, in the present invention, a divided storage area of one physical disk is set to be in a pair with a divided storage area of another physical disk.

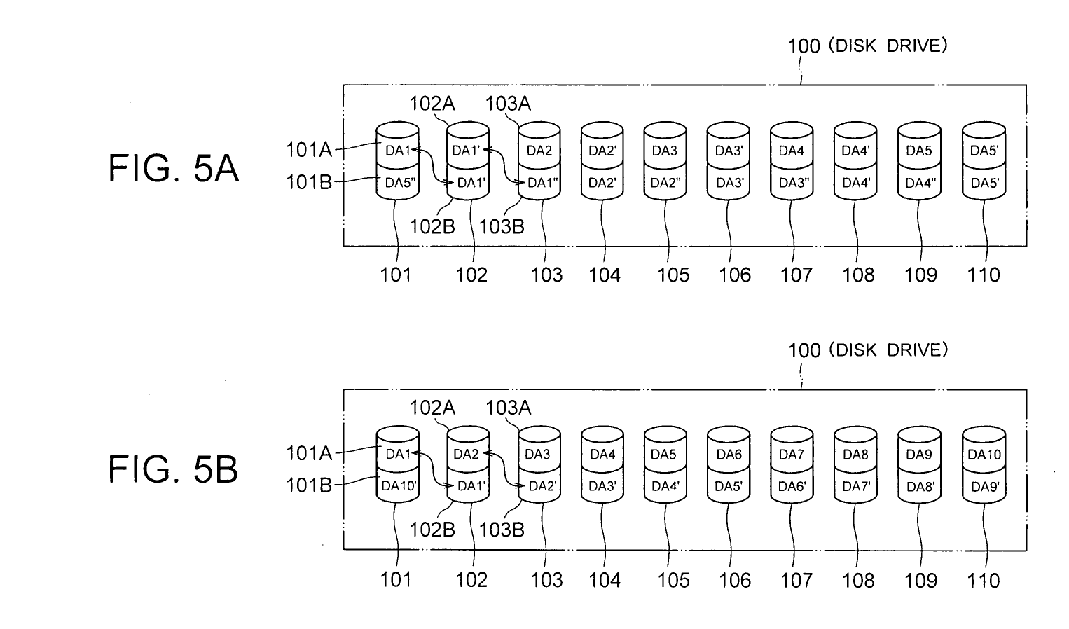

Explanation will be given for the pair as an example. As shown in FIG. 5(a) described later, a pair is made between a divided storage area of one physical disk and a divided storage area of the other physical disk, and also a pair is made between a divided storage area of one physical disk and another divided storage area of the other physical disk. Alternatively, a pair is made between a divided storage area of one physical disk and a divided storage area of the other physical disk, as shown in FIG. 5(b) described later.

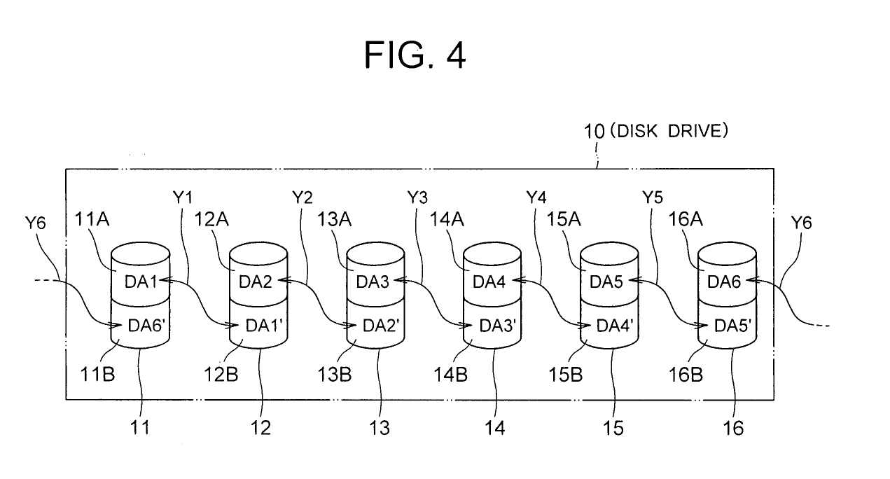

Next, explanation will be given for a pair made between a divided storage area of the one physical disk and a divided storage area of the other physical disk, which is common to the aforementioned examples. Here, one divided area of the pair onto which the same data is stored, is set to a block A of one physical disk, and another divided area of the pair is set to a block B of another physical disk. Further, a block A of the other physical disk is set to be in a pair with a block B of yet another physical disk, which is other than the aforementioned one physical disk or another physical disk. More specific explanation will be given with reference to FIG. 3. When explaining with reference to a physical disk shown by the numeral 12, a pair of divided areas, onto which the same data is stored, are set to a block A of a physical disk 12, that is, 12A, and a block B of another physical block 13, that is, 13B, respectively. Thereby, the block A of the physical disk 12, that is, 12A and the block B of the physical disk 13, that is, 13B are paired, and the same data is written onto the block 12A and the block 13B. Further, a block A of the physical disk 13, that is, 13A, and a block B of a physical disk 14, that is, 14B are set as a pair of divided areas onto which the same data is written. In the similar manner, blocks A of physical disks 14, 15, 16 and 11, that is, 14A, 15A, 16A and 11A, and blocks B of physical disks 15, 16, 11, and 12, that is, 15B, 16B, 11B and 12B, are set as pairs onto which the same data is written respectively, as shown in FIG. 4. Note that the relationships between pairs of blocks A and blocks B are shown by the arrows Y1 to Y6.

Correlation data of a pair of divided areas, showing the correlation between a block A and a block B set as a pair of divided areas, is stored on a storage area (nonvolatile memory, etc.,) in a RAID controller 20 which is a controller of the device. The RAID controller 20 performs a management function of maintaining the same data on a block A of a physical disk 11-16 and a block B of another physical disk 12, 13, 14, 15, 16 or 11, based on the correlation data.

The RAID controller 20, or the controller or the device, is constructed from a RAID control unit 21 for managing the RAID construction, a disk driver 22 for managing accessing to physical disks, and a mirror control unit 23 for executing copying. In particular, the mirror control unit 23 is provided with a mirroring execution function, that is, a function of writing the same data onto a pair of divided areas (blocks A, B) in physical disks 11-16, based on correlation data stored in the RAID controller 20.

Among the RAID systems, RAID 1 and RAID 5 will be explained specifically. RAID 1 is a system in which the same data is written onto two physical disks, and the data is protected against a fault occurred in one physical disk. RAID 5 is a system in which writing data is divided into plural pieces of data, and then pieces of parity data are generated corresponding to the pieces of divided writing data, and the divided writing data and the parity data are written, as pairs, onto plural disks, respectively.

In the disc array device of the present invention, either one of a pair of divided areas is set to be a data writing area. For example, if a divided area 12A of the physical disk 12 and a divided area 13B of the physical disk 13 are made into a pair, one of them, that is, the divided area 12A, is set as a data writing area. Then, writing area specifying data, indicating that the divided area 12A is the data writing area of the pair of divided areas, is stored on the storage area of the RAID controller 20. The writing area specifying data is stored on, for example, a memory in the disk driver 22. This also applies to other pairs of divided areas.

Along with this, the RAID controller 20, for example, the disk driver 22 has a function of writing, on a data writing area, writing data according to an instruction form the host device 30, based on the writing area specifying data. Then, with the mirroring execution function described above, the same data as that in the data writing area is written (copied) onto a divided area paired therewith, based on the correlation data indicating the correlation of the pair of divided areas. In this way, by writing data on only one physical disk of the pair, the written data is copied to another physical disk, whereby data writing is only needed to be performed to one physical disk. Thereby, it is possible to speed up data writing while keeping the data redundancy. The operation of the mirroring function will be explained in detail with reference to FIG. 4.

FIG. 4 shows the disk drive disclosed in FIG. 3. In FIG. 4, data DA1, DA2 or the like is written on each block 11A, 11B or the like of each physical disk 11-16. For example, in the physical disk 12, the storage area is divided into areas of block A (12A) and block B (12B), each of which has the same capacity, and the block A (12A) makes a pair with a block B of the physical dick 13 (13B) (see arrow Y2). Further, a block B of the physical disk 12 (12B) makes a pair with a block A of the physical disc 11 (11A) (see arrow Y1). When a command is issued from the disk driver 22 to the block A of the physical disk 12 (12A), the mirror control unit 23 executes copying to the block B of the physical disk 13 (13B) which is paired with the block A (12A). Thereby, the data (DA2) written on the block A of the physical disk 12 (12A) is copied to the block B of the physical disk 13 (13B) (DA′2).

The mirror control unit 23 operates similarly to other blocks. When the disk drive 10 is constructed from N numbers of physical disks, a block A of the N^{th} physical disk (in FIG. 4, a physical disk indicated by the numeral 16) (16A) makes a pair with a block B of the first physical disk 11 (11B), and a block B of the N^{th} physical disk (16B) makes a pair with a block A of the N−1^{th} physical disk 15. In this way, respective blocks make pairs with each other (see arrows Y1-Y6). When a command is issued from the disk drive 22 to each block A (11A, 12A, 13A, 14A, 15A, 16A), the mirror control unit 23 recognizes each block B (12B, 13B, 14B, 15B, 16B, 11B) making a pair with each block A, based on the correlation data stored beforehand, and executes mirroring, whereby data on each block A (DA1, DA2, DA3, DA4, DA5, DA6) is copied to each block B making a pair. Data copied to each block B, corresponding to the data of each block A by the mirroring, is indicated by the numeral DA1′, DA2′, DA3′, DA4′, DA5′ or DA6′.

In this way, in the present invention, the disk capacity (storage capacity) of a single physical disk in the disk array device is divided in to two blocks of areas having the same capacity, each being assumed as block A or block B. The block A makes a pair with a block B, with the same capacity, of another physical disk, and the block B makes a pair with a block A of yet another physical disk. Data is written onto a block A, and the data written on the block A is copied to a block B. Thereby, even in a case where a fault occurs in a physical disk unexpectedly, a spare disk is not required since a physical disk is area-divided and the data is duplicated on another physical disk automatically, such that the fault tolerance can be improved. Further, since an unnecessary spare disk is not used, it is possible to suppress an increase in the number of physical disks, to reduce the product cost and to miniaturize the device. In particular, all divided areas have the same capacity, whereby every data is surely copied and the data reliability increases.

Further, the RAID controller 20 has a replacement recognition function for recognizing a replacement of a physical disk. For example, the disk driver 22 regularly monitors the operating state of each physical disk 11-16, and when a fault occurs, recognizes a degeneration and a new physical disk being mounted after detachment. Along with the replacement, the mirror control unit 23 has a function of recognizing a divided area making a pair with the divided area of the replaced physical disk based on the correlation data, and writing the same data as that stored on the area onto a divided area of the replaced physical disk. Thereby, when a physical disk is failed, the physical disk is replaced such that the data is copied onto a divided area replaced. Then, the RAID control unit 21 restores data required for writing onto a new disk replaced with the failed physical disk, from the data copied from the failed physical disk to another physical disk and from data written on the normal disks, according to a data restore processing function.

Further, the RAID controller 20 of the present disk array device 1, in particular, the RAID control unit 21 and the disk driver 22 have a function of reading data from either one of a pair of divided areas of the physical disks 11-16, based on the correlation data, when reading out data. For example, from block A (11A, for example) of each physical disk 11-16, the data DA1 stored in the block is read out, according to an instruction from the host device 30. Thereby, accessing is required to only one of physical disks paired, when reading data, while keeping redundancy and suppressing unnecessary increase in the physical disks. This enables to reduce accessing period.

### EXAMPLE 1

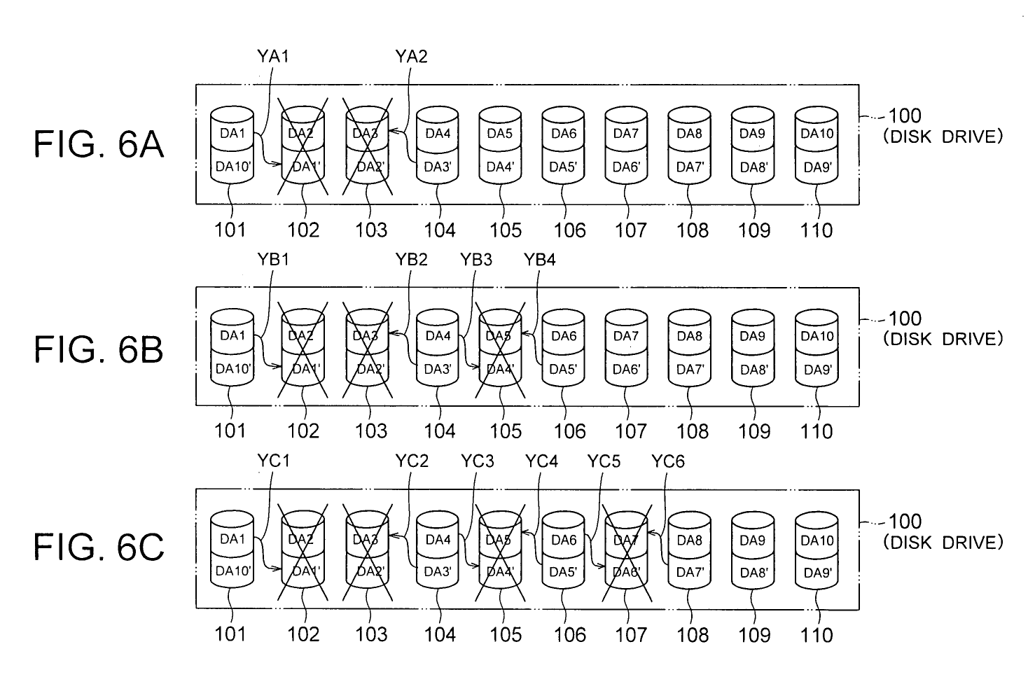

A specific example of the present invention will be described with reference to FIGS. 5 and 6.

Although a case in which the present invention is not applied to RAID has been explained above, FIG. 5(a) shows an example in which the disk array device 1 of the present invention is applied to a RAID 1 device corresponding to the RAID 1 level.

A disk drive 100 shown in this Figure is composed of ten physical disks 101-110, and the storage area of each physical disk is divided into two storage areas having the same capacity. Each divided area makes a pair with another divided area, provided that the physical disks of a pair are different. For example, a block A of the physical disk 101 (101A) and a block B of the physical disk 102 (102B) make a pair (see arrow in the Fig.) Other divided areas also make pairs in the similar manner. In such a configuration, first data DA1 stored on the area 101A of the physical disk 101 is written onto the area 102A of the physical disk 102 as data DA1′ by the act of RAID 1. Similarly, the data DA1′ is also written onto the area 102B of the physical disk 102 making a pair with the area 101A of the physical disk 101 by the act of the aforementioned mirroring function. Further, by the act of the aforementioned RAID 1, the data DA1′ written onto the area 102A of the physical disk 102 is copied by the mirroring function onto an area 103B of a physical disk 103 making a pair with the area 102A of the physical disk 102 (data DA1″). Thereby, it is possible to suppress unnecessary increase in the number of physical disks and to improve the fault tolerance of the physical disks.

Next, an example in which the disk array device of the present invention is applied to a RAID device corresponding to RAID 5 level will be described, with reference to FIG. 5(b).

In the example shown in this Figure, the disk drive 100 is composed of ten physical disks 101-110, and the storage area of each physical disk is divided into two areas (area 101A, 101B, or the like), similar to the case shown in FIG. 5(a).

In RAID 5, writing data written according to an instruction from a host device not shown is divided into plural pieces of data, and plural pieces of parity data are generated corresponding to the divided pieces of data. Then, the divided pieces of writing data and the pieces of parity data corresponding thereto make pairs, respectively. Each pair of data is stored onto block A of each physical disk 101-110. The data (DA1-DA10) written on a block A (101A-110A) is copied to a block B (101B-110B) of another physical disk making a pair therewith (DA1′-DA10′). This correlation is almost similar to the one shown in FIG. 4.

A restoring operation when plural physical disks are failed in the case of the device being applied to RAID 5 will be described, with reference to FIGS. 6(a) to 6(c). FIG. 6(a) shows a case where two physical disks 102 and 103 are failed.

In this case, the two failed physical disks 102 and 103 are replaced with two normal physical disks 102 and 103. When the physical disks 102 and 103 are replaced, the RAID controller 20 recognizes two new physical disks 102 and 103.

Next, the RAID controller 20 reads out data DA1 from the block A of the physical disk 101, and reads out data DA3′ from the block B of the physical disk 104, and then reads out data DA4, DA5, DA6, DA7, DA8, DA9 and DA10 from blocks A of the remaining normal physical disks 104, 105, 106, 107, 108, 109 and 110, respectively.

Then, the RAID controller 20 reconstructs the missing data DA2 by using the read out plural pieces of data DA1, DA3′, DA4, DA5, DA6, DA7, DA8, DA9 and DA10 and the parity data. A system of reconstructing this data is a general one used for data reconstruction in RAID 5, whereby the details are omitted.

Next, the RAID controller 20 writes the reconstructed data DA2 onto the block A of the new physical disk 102. Further, the RAID controller 20 copies the data DA2 written on the block A of the physical disk 102 to the block B of the new physical disk 103, and also copies the data DA3′ written on the block B of the physical disk 104 to the block A of the new physical block 103, respectively (see arrow YA2). Further, the RAID controller 20 copies the data DA1 written on the block A of the physical disk 101 to the block B of the new physical disk 102 (see arrow YA1).

Through the aforementioned processing, the pieces of data DA1′, DA2 and DA3, which should be stored on the failed physical disks 102 and 103, are restored.

When three physical disks 102, 103 and 105 are failed as shown in FIG. 6(b), the three failed physical disks 102, 103 and 105 are replaced with three normal physical disks 102, 103 and 105. When the three new physical disks 102, 103 and 105 are replaced, the RAID controller 20 recognizes the three new physical disks 102, 103 and 105.

Next, the RAID controller reads out data DA1 from the block A of the physical disk 101, reads out data DA3′ from the block B of the physical disk 104, reads out data DA4 from the block A of the physical disk 104, and reads out data DA5′ from the block B of the physical disk 106. Further, the RAID controller reads out pieces of data DA6, DA7, DA8, DA9 and DA10 from blocks A of the remaining normal physical disks 106, 107, 108, 109 and 110, respectively.

Then, the RAID controller 20 reconstructs the missing data DA2 by using the read out plural pieces of data DA1, DA3′, DA4, DA5′, DA6, DA7, DA8, DA9 and DA10 and parity data. A system of reconstructing the data is a general one used for data reconstruction in RAID 5, whereby the details are omitted.

Next, the RAID controller 20 writes the reconstructed data DA2 onto the block A of the new physical disk 102. Further, the RAID controller 20 copies the data DA2 written on the block A of the physical disk 102 to the block B of the new physical disk 103, and also copies the data DA3′ written on the block B of the physical disk 104 to the block A of the new physical block 103, respectively (see arrow YB2). Further, the RAID controller 20 copies the data DA1 written on the block A of the physical disk 101 to the block B of the new physical disk 102 (see arrow YB1) Further, the RAID controller 20 copies the data DA4 written on the block A of the physical disk 104 to the block B of the new physical disk 105 (see arrow YB3). Further, the RAID controller 20 copies the data DA5′ written on the block B of the physical disk 106 to the block A of the new physical disk 105 (see arrow YB4).

Through the aforementioned processing, pieces of data which should be stored in the failed physical disks 102, 103 and 105 are restored.

Further, when four physical disks 102, 103, 105 and 107 are failed as shown in FIG. 6(c), the four failed physical disks 102, 103, 105 and 107 are replaced with four normal physical disks 102, 103, 105 and 107. When the physical disks 102, 103, 105 and 107 are replaced, the RAID controller 20 recognizes the four new physical disks 102, 103,105 and 107.

Next, the RAID controller 20 reads out data DA1 from the block A of the physical disk 101, reads out data DA3′ from the block B of the physical disk 104. Further, the RAID controller 20 reads out data DA4 from the block A of the physical disk 104, reads out data DA5′ from the block B of the physical disk 106, and reads out data DA7′ from the block B of the physical block 108. Further, the RAID controller 20 reads out pieces of data DA8, DA9 and DA10 from blocks A of the remaining normal physical disks 108, 109 and 110, respectively.

Then, the RAID controller 20 reconstructs the missing data DA2 by using the read out plural pieces of data DA1, DA3′, DA4, DA5′, DA6, DA7′, DA8, DA9 and DA10 and parity data. A system of reconstructing the data is a general one used for data reconstruction in RAID 5, whereby the details are omitted.

Next, the RAID controller 20 writes the reconstructed data DA2 onto the block A of the new physical disk 102. Further, the RAID controller 20 copies the data DA2 written on the block A of the physical disk 102 to the block B of the new physical disk 103, and also copies the data DA3′ written on the block B of the physical disk 104 to the block A of the new physical disk 103, respectively (see arrow YC2). Further, the RAID controller 20 copies the data DA1 written on the block A of the physical disk 101 to the block B of the new physical disk 102 (see arrow YC1) Further, the RAID controller 20 copies the data DA4 written on the block A of the physical disk 104 to the block B of the new physical disk 105 (see arrow YC3). Further, the RAID controller 20 copies the data DA5′ written on the block B of the physical disk 106 to the block A of the new physical disk 105 (see arrow YC4). Further, the RAID controller 20 copies the data DA6 written on the block A of the physical disk 106 to the block B of the new physical disk 107 (see arrow YC5). Further, the RAID controller 20 copies the data DA7′ written on the block B of the physical disk 108 to the block A of the new physical disk 107 (see arrow YC6).

Through the aforementioned processing, the pieces of data which should be stored in the failed physical disks 102, 103, 105 and 107 are restored.

In this way, the disk array device 1 according to the present invention can keep the high data redundancy rate even when a number of disks are failed, and is also capable of suppressing an increase in the number of disks, miniaturizing the device, and reducing the cost. For example, a comparison will be made between the conventional disk array device of the mirror/RAID combined system described in the aforementioned Patent Document 1 and the disk array device of the present invention. Assuming that the storage capacity of a physical disk of the present invention is X, and the storage capacity of a physical disk described in Patent Document 1 is ½. In this condition, the whole storage capacity according to the present invention is 10X in a case of ten physical disks, and the whole storage capacity in the conventional art is 10X in a case of ten pairs of physical disks, that is, twenty physical disks, whereby the same capacity can be realized.

Now, when considering the cost per physical disk, assuming that (one with the storage capacity X): (one with the storage capacity ½*X)=7:4, for example, the whole cost per disk is 70:80, which results in that the present invention is less costly. The present invention is capable of suppressing the disk cost, even with the same storage capacity for writing data. Therefore, the difference in disk cost becomes larger as the number of disks constituting the device increases. Moreover, the present invention can save the occupation space required for a plurality of physical disks, whereby the cost can be further suppressed.

Further, a comparison will be made between the conventional device of the redundant disk system described in the aforementioned Patent Document 2 and the disk array device of the present invention. Assuming that the storage capacity of a physical disk of the present invention is X, and the storage capacity of a physical disk described in Patent Document 2 is ½. In this condition, the whole storage capacity according to the present invention is 10X in the case of ten physical disks. On the other hand, the whole storage capacity in the conventional art becomes 8.5X in the case of seventeen physical disks, which capacity is smaller than the present invention.

Now, when considering the cost per physical disk, assuming that (one with the storage capacity X): (one with the storage capacity ½*X)=7:4, for example, the whole cost per disk is 70:68, which is almost the same.

This means that even with a physical disk having smaller storage capacity, the basic structure of a disk device for reading and writing data to physical disks requires the same cost as that of a physical disk with larger storage capacity. As a result, the ratio of the entire physical disk cost is approximated as described above.

As the number of disks constituting the device increases, the number of redundant disks of the redundant disk system of the conventional art also increases. Therefore, the cost spent will be reversed to be lower in the present invention.

Further, since the present invention has less number of physical disks, the space for accommodating the physical disks is reduced by the number of redundant disks, so that casings for mounting physical disks can also be reduced. Thereby, the cost can be suppressed. Further, when one physical disk is failed, reconstruction is to be completed when copying is completed in the present invention. However, in the case of using a redundant disk, reconstruction is to be completed when processing of copying to a redundant disk and copying to the replaced physical disk from the redundant disk is completed. Thereby, a nonredundant state may exist in the system of using redundant disks. In contrast, the present invention has no nonredundant period, whereby the data reliability can be improved.

As described above, in the present invention, one physical disk shares plural pieces of data, whereby the respective pieces of data stored in one physical disk are copied to and stored on divided areas formed on different physical disks. Thereby, even when a number of physical disks are failed, it is possible to easily restore the data and to maintain the data redundancy. Further, the present invention is capable of suppressing an increase in the number of physical disks, reducing the cost of device, and miniaturizing the device. In particular, all divided areas have the same capacity, whereby all data can be surely copied, which enhances the data reliability.

Note that although cases of applying the present invention to RAID 1 and RAID 5 have been explained in the aforementioned embodiment, there are RAID 0, RAID 2, RAID 3 and RAID 4 systems besides the aforementioned systems.

RAID 0 is a system in which data is divided in block units and stored distributively in a number of physical disks (striping). RAID 2 is a system in which ECC (Error Correction Code, also called as Hamming code), used in the main storage or the like, is used for detecting and correcting data errors. In this system, data is divided in bit units or byte units and stored on a number of dedicated physical disks. RAID 3 is a system in which data is divided in bit units or byte units, and is written on a number of dedicated physical disks simultaneously. From the divided piece of data, parity is generated and written on a physical disk dedicated for parity. Accessing is always made in parallel to all physical disks, and the data is transferred in a bundle. RAID 4 is a system provided with a function of reconstructing data by adding a physical disk dedicated for parity to the striping of RAID 0. Data is divided in block units and written on physical disks for data, and parity is written on one physical disk dedicated for parity. The present invention can be applied similarly to these RAID systems.

### Industrial Applicability

As described above, the present invention can be used as a storage providing high reliability of data stored, by connecting with a host device such as a computer, and is industrially applicable.

1. A disk array device comprising:
a plurality of physical disks; and
a controller which performs reading and writing of data to storage areas of the physical disks according to an instruction from a host device, wherein
in each of the physical disks, a storage area is divided into a plurality of areas, and
divided storage areas of one physical disk are set to make pairs with divided storage areas of another physical disk.

2. The disk array device, as claimed in claim 1, wherein
pairs are made between a divided storage area of one physical disk and a divided storage area of another physical disk, and between a divided storage area of the one physical disk and another divided storage area of the other physical disk.

3. The disk array device, as claimed in claim 1, wherein a pair is made between a divided storage area of one physical disk and a divided storage area of another physical disk.

4. The disk array device, as claimed in claim 1, wherein
the controller holds correlation data for corresponding a pair of storage areas to each other, and has a managing function of maintaining same data on the pair of storage areas, based on the correlation data.

5. The disk array device, as claimed in claim 1, wherein a plurality of storage areas being in pairs have a same storage capacity.

6. The disk array device, as claimed in claim 1, wherein the storage area of each physical disk is divided into two storage areas.

7. The disk array device, as claimed in claim 6, wherein the two storage areas divided have a same storage capacity.

8. The disk array device, as claimed in claim 4, wherein
one of storage areas being in a pair is set as an area for writing data, and
the controller holds writing area specifying data for specifying the storage area as a data writing area, and has a function of writing, on the storage area, writing data according to an instruction from the host device, based on the writing area specifying data, and also has a function of copying same data as that written on the storage area to a storage area making a pair therewith.

9. The disk array device, as claimed in claim 4, wherein the controller has a function of reading out written data from one of the storage areas being in a pair, based on the correlation data.

10. The disk array device, as claimed in claim 4, wherein the controller has a function of recognizing a replacement of a physical disk, and upon recognition of the replacement, has a function of copying data, stored on a storage area of another physical disk making a pair, to a storage area of the physical disk replaced.
